(19) United States
(12) Patent Application Publication
(10) Pub. No.: US 2021/0071413 A1
(43) Pub. Date: Mar. 11, 2021

(54) HEAT INSULATING ELEMENT, BUILDING CONSTRUCTION AND METHOD FOR AVOIDING MOISTURE DAMAGE AT A BUILDING

(71) Applicant: SAINT-GOBAIN ISOVER, Courbevoie (FR)

(72) Inventor: Anatol Worch, Kamen (DE)

(21) Appl. No.: 17/053,637

(22) PCT Filed: May 22, 2019
(86) PCT No.: PCT/EP2019/063230

§ 371 Date: Nov. 6, 2020

(30) Foreign Application Priority Data
May 22, 2018 (DE) 10 2018 112 260.8

(51) Int. Cl. E04B 1/80; E04B 1/76; E04C 2/296; E04D 11/02; E04D 13/16; B32B 5/02; B32B 19/06; B32B 21/02; B32B 21/10

(52) U.S. Cl. CPC E04B 1/80; B32B 2262/108; E04B 1/7675; E04C 2/296; E04D 11/02; E04D 13/1618; B32B 5/02; B32B 19/06; B32B 21/02; B32B 21/10; B32B 2307/304; B32B 2419/06; B32B 2262/101; B32B 2262/02; E04B 1/7645

(57) ABSTRACT

The invention relates to a heat insulating element (4) for an interior insulation, a facade insulation, a roof insulation, or the like at a building (1), comprising an insulating body (41) which is of diffusion-open design. The heat insulating element (4) is characterized in that it further comprises a fabric (42), especially a fleece, which is of capillary-active design, and that the fabric (42) is arranged on a surface of the insulating body (41). Furthermore, the invention relates to a building construction, to a method for avoiding moisture damage at a building (1), and to the use of a heat insulating element of this type. This achieves an improved heat insulating element (4) for avoiding moisture damage at a building (1) by means of which it is possible to accelerate drying of the region concerned in the case of the accumulation of water, especially condensation water, with simple means. Furthermore, an appropriate building construction is provided in which moisture damage can be avoided more reliably, and an improved method for avoiding moisture damage at a building (1) is provided.

### BACKGROUND OF THE INVENTION

The invention relates to a heat insulating element for an interior insulation, a facade insulation, a roof insulation, or the like at a building, comprising an insulating body which is of diffusion-open design. The invention relates further to a building construction in accordance with the preamble of claim 7, to a method for avoiding moisture damage at a building in accordance with claim 12, and to the use of a heat insulating element of this type in accordance with claim 15.

Nowadays, when constructing buildings, the application of a heat insulation belongs to standard so as to avoid the loss of energy through the shell of the building. Accordingly, roofs are regularly provided with an insulating layer which may be disposed at the inside or else at the outside. The same applies for the outer walls of the building which can, as a rule, not enfold sufficient heat insulation from their intrinsic structure. Usually, insulating layers are arranged here at the outside in the kind of a heat insulation compound system. If this is not possible, such as for instance in the case of buildings having listed facades, it is, however, also known to insulate the wall elements at the inner side.

The walls and roof structures, however, basically have to be protected from moisture penetration. Especially when diffusion-open insulating materials such as mineral wool are used, it is important to prevent the entry of moisture preferably right from the start. Among experts, very precise requirements exist in the normative guidelines, which regulate, for instance, the designing of the water vapor diffusion resistances at the sides of a mineral wool insulation at a steep roof, so that no damage may occur in the long run. In practice, suitable systems for roof structures and/or facade designs have been developed in this respect.

These normative requirements can, however, not deal with any case of damage, for instance, at a sarking membrane of a steep roof. Then, the entry of moisture in a roof structure, for example due to rain, can no longer be prevented reliably.

While the problem of the entry of moisture from the outside at roof structures and facades has traditionally been mastered very well, there are, especially in the heating period, problems at the insulating layers within the wall and/or the roof structure due to the forming of condensation water. This is especially problematic in the case of an interior insulation of the building. Here, the outer walls are not within the thermal sheath, i.e. the insulating plane. If the interior is heated, for instance, in the winter, a large temperature difference will appear across the insulating plane. In this case, however, the wall element does not absorb the temperature of the warm inner side, but is cooled through at the outside air. Due to the warm, moist air impinging on the cool outer wall, condensation water may be produced at this place between the insulating plane and the outer wall, which may result in consequential damage at the building. It is essential that this be avoided.

Condensation water is produced in relation with the temperature profile in the building, for instance, an outer wall, and the saturated vapor pressure at different temperatures. The amount of humidity to be absorbed maximally by the air depends on the existing temperature. For the water vapor diffusion through a building component the water vapor pressure difference is the driving force. The water vapor pressure depends on the temperature and the relative air humidity. With a constant temperature the vapor pressure is a linear function of the relative air humidity. If a temperature difference exists in addition, this results in the appearance of a vapor diffusion stream as a rule from high to low temperatures, even if the relative air humidity at warm temperatures, i.e. at the inner side, related to the cold temperatures, i.e. at the outer side, is identical or even lower. From a certain point on, the difference of the water vapor concentration can no longer be borne by the cooler air and precipitates as condensation water. If this area in which liquid water is produced is within a building component, damage of the building component may occur.

Among experts, numerous proposals have already existed for eliminating moisture problems of this kind. In some proposals the capillary-active effect of substances is used in order to guide penetrated water and/or produced condensation water off the area concerned, and to thus dry the corresponding area. Examples thereof result from DE 101 46 174 A1, EP 1 657 496 A2, DE 10 2007 025 303 A1, DE 20 2009 008 493 U1, DE 10 2008 035 007 A1, EP 2 186 958 A2, DE 10 2011 113 287 A1, EP 2 666 625 A1, DE 10 2012 018 793 A1, DE 10 2012 219 988 A1, and EP 3 031 992 A1. In these cases the insulating layer itself is designed to be capillary-active, or it is penetrated by capillary-active elements. In the capillary-active areas the moisture is thus sucked in, guided off the wall and/or the roof structure, and taken to an area where the moisture may evaporate. EP 3 031 992 A1, for instance, uses such capillary-active segments penetrating the insulating material, and a wall-side coating to guide liquid by means of capillary guidance from the one side to the other side of the insulating layer.

It has, however, turned out in practice that such systems work insufficiently only. Specifically, it is by no means the case that the capillary activity would be effective in one direction only, which is why the moisture indeed distributes across the insulating layer, but then an equilibrium is reached, so that a substantial share of moisture remains in the critical area nevertheless.

Moreover, such capillary-active elements are complex and expensive to produce. Their processing when being installed at the building construction is also more difficult than with conventional systems.

It is therefore an object of the invention to provide an improved heat insulating element for avoiding moisture damage at a building, by means of which drying of the area concerned can be accelerated with simple means if water, especially condensation water, accumulates. Furthermore, it is an object of the invention to provide an appropriate building construction in which moisture damage can be avoided more reliably, and to provide an improved method for avoiding moisture damage at a building.

In accordance with a first aspect of the present invention the object is solved by a heat insulating element with the features of claim 1. It is characterized in particular in that the heat insulating element further comprises a fabric, especially a fleece, of capillary-active design, and that the fabric is arranged on a surface of the insulating body.

The invention is based on the finding that the drying of water penetrated in a building construction or accumulated therein can be accelerated substantially if a distribution of the moisture on a larger area is achieved by means of a capillary-active fabric. The water distributes in the layer formed by the fabric and then dries at the substantially larger surface. The evaporation of the water is moreover supported substantially by the fact that the insulating body is at the same time of diffusion-open design and thus permits the moisture to be carried off.

The active principle can be explained illustratively by means of a heat bridge in a building corner of an interior insulation. During the winter period, condensation water may occur directly in the heat bridge in the plane between the brickwork and the interior insulation. This condensation water remains naturally in the building corner and takes a long time to dry again since exactly in these corner regions a very small surface is available for discharging the water vapor into the ambient air. With the use of the capillary-active fabric in accordance with the invention in the condensation plane, i.e. in the layer between the wall and the interior insulation, accumulating condensation water is now absorbed and distributed in correspondence with the capillary transporting properties of the fabric. Thus, the area across which the amount of condensation water may dry toward the inner face is increased. This increase of the drying face thus results in substantially quicker drying and hence in a long-term higher damage freedom of the building construction.

The accelerated drying process may, however, also be used equally if, due to damages to a sarking membrane of a steep roof, a facade or the like, rain water, melt water, etc. penetrates into the building construction. Here, too, the capillary-active design of the fabric causes an immediate distribution of the moisture to a larger area and allows for quick drying thereof.

Moreover, this can be done with a particularly low constructional effort. The arrangement and/or application of fabrics on an insulating body is possible with approved means in production-technical respect. It is not necessary to penetrate the insulating body with a capillary-active element. In accordance with the invention the fabric is merely disposed on a large surface of the insulating body.

By means of the heat insulating element in accordance with the invention it is thus possible to achieve in a very simple and quick manner a suitable building construction for avoiding moisture damage. Moreover, the capillary-active fabric protects the building construction in a reliable manner in the long term.

Apart from the low effort for providing the heat insulating element in accordance with the invention, such construction of a building can be implemented in a particularly cost-efficient and time-saving manner. At the same time, this does not require any additional processing steps or measures that would be unusual for the operator.

From practice, insulating elements with a fabric lamination have indeed become known, which are, for instance, used for interior insulation. The fabric lamination, however, is available always toward the side of the interior and serves as a trickle protection for the mineral wool material or the like. Therefore, it cannot contribute to the avoiding of condensation water accumulation and to the elimination thereof.

Advantageous further developments of the heat insulating element in accordance with the invention are the subject matter of the dependent claims 2 to 6.

It has turned out to be advantageous if the fabric comprises a capillarity for water with a capillary rise of more than 15 cm. It applies basically that the distribution of the condensation water or the like takes place the more efficiently the larger the capillarity of the fabric is. With a capillary rise of more than 15 cm very good drying results could already be achieved in practical tests. Preferably, the capillary rise for water is more than 20 cm, which results in an even larger and better distribution of the moisture and hence even better evaporation thereof.

It is per se irrelevant of which material the fabric is made. It merely has to have a structure which admits capillary activity. However, fabrics of glass fibers or plastic fibers have turned out to be particularly suited for the common use at a building. They are of sufficiently diffusion-open, homogeneous, and robust design for the usual purpose of application.

It is of further advantage if the fabric is laminated on the insulating body. Then, it can be connected reliably with the insulating body with an approved method and need not be handled separately.

The diffusion openness of the insulating body is of further importance for evaporation. It has turned out to be advantageous if it has a μ value of ≤3. With this water vapor diffusion resistance number the resistance is expressed with which a body counteracts the diffusion of water vapor. The smaller the value, the less resistance is thus offered to the water vapor diffusion, and the better can the moisture be guided off by the insulating body. Preferably, the insulating body has a μ value of ≤2, which corresponds to an even better diffusion openness.

If the insulating body is made of mineral wool, a material is used which has been very approved in insulation technology. Mineral wool has good insulating values, is flame-retardant, and diffusion-open. Alternatively, natural fibers such as in particular soft wood fibers may also be used for the insulating body, which is, for ecologic reasons, also frequently desired in building construction. These materials are also of diffusion-open design.

In accordance with a further aspect of the present invention, according to claim 7 a building construction is provided with a separator between an inner side and an outer side of a building, wherein the inner side corresponds to a warm side of the building and the outer side corresponds to a cold side of the building, and with a plurality of heat insulating elements which each comprise an insulating body of diffusion-open design. This building construction is characterized in that a fabric which is of capillary-active design is arranged on a surface of the insulating body, and that the fabric is arranged to face the cold side of the building.

In the case of a building construction of such design it is thus reliably possible to guide moisture off the construction. Due to the capillary-active fabric a large-face distribution of the moisture is achieved, which promotes the evaporation thereof.

Due to the fact that the fabric is arranged to face the cold side of the building, it is moreover available at a position at which the accumulation of moisture and/or the entry of moisture is to be expected. Thus, this measure is effective exactly in the region in which the demand is highest.

In this manner, i.e. by the increased drying potential, it is advantageously possible to avoid moisture damage at the building construction in a very reliable and permanent manner. At the same time, this may be implemented with little provision effort, processing requirements, and hence also costs.

Advantageous further developments of the building construction in accordance with the invention are the subject matter of the dependent claims 8 to 11.

Thus, the separator may be a wall element, and the heat insulating elements may form an interior insulation, wherein the fabric is arranged to face the wall element. Then, the classical problem of an interior insulation exists, which may lead to condensation water between the insulating layer and the wall. In this case, the fabric is thus available between the heat insulating elements and the wall element and absorbs possible water in this place and/or distributes same to a larger face. The moisture may then diffuse through the diffusion-open insulating bodies of the heat insulating elements and be dissipated to the interior of the building. Moisture damage such as the formation of mold or the like can thus be avoided in a particularly reliable manner.

Alternatively, it is also possible that the separator is a wall element and the heat insulating elements form a facade insulation, wherein the fabric is arranged to face away from the wall element toward the outer side. Then, moisture occurring at this place may, also in this embodiment, be distributed reliably to a larger face and be dissipated above all to the outside, e.g. into a plaster layer. A temporary accommodation of the moisture in the diffusion-open insulating bodies of the heat insulating elements is also possible, so that a water congestion at this place may be avoided. Thus, moisture damage at the building can be avoided reliably.

In a further alternative it is also possible that the separator is a roof structure and the heat insulating elements form a roof insulation, wherein the fabric is arranged to face away from the roof structure toward the outer side. Like in the foregoing variant it is thus possible to avoid the accumulation of moisture at one place by the moisture being distributed across a larger area due to the capillary effect of the fabric. Evaporation of the moisture and drying of the building construction in this area is thus possible in a particularly reliable manner.

Moreover, the heat insulating element may also be further developed in correspondence with the features of claims 2 to 6, so that the building construction takes direct advantage of the effects of the heat insulating element in accordance with the invention.

In accordance with yet another aspect of the present invention a method for avoiding moisture damage at a building is provided in accordance with claim 12. The building comprises a separator such as a wall element or a roof structure and is equipped with heat insulating elements. The separator is arranged between an inner side and an outer side of the building, wherein the inner side corresponds to a warm side of the building and the outer side corresponds to a cold side of the building. The heat insulating elements each comprise an insulating body which is of diffusion-open design and comprises a fabric on a surface, wherein the fabric is of capillary-active design, and wherein the fabric is arranged to face the cold side of the building. The method in accordance with the invention comprises the steps of: occurring of a moisture accumulation in the area of the fabric, extensively distributing the moisture due to the capillary-active properties of the fabric for increasing the area of evaporation, guiding off the moisture by evaporation and thus drying the area concerned of the fabric.

With the method in accordance with the invention it is possible to achieve the above-explained advantages with respect to the heat insulating element according to claim 1 and/or the building construction according to claim 7 in an analogous way. Specifically, moisture damage at a building can thus be avoided reliably and permanently in a simple and cost-efficient manner.

Advantageous further developments of the method in accordance with the invention are the subject matter of the dependent claims 13 and 14.

Thus, the moisture may be guided off by means of diffusion through the diffusion-open insulating body. This is expedient above all in the case of interior insulation since the wall element here acts as a kind of barrier body and the air at the warm inner side is moreover better suited to absorb moisture.

Alternatively it is also possible that the moisture is guided off by evaporation from the side of the fabric which faces away from the insulating body. This is expedient above all with insulating layers arranged at the outer side. Then, reliable removal of the moisture may be achieved by the larger evaporation face of the capillary-active fabric.

In accordance with yet another aspect of the invention the use of a heat insulating element according to the invention is claimed in accordance with claim 15 for an interior insulation, a facade insulation, a roof insulation, or the like at a building.

A heat insulating element used in this manner is of advantage for all these different insulation variants at a building in that moisture damage is avoided in a particularly reliable manner. Moreover, with the use of the heat insulating element in accordance with the invention a cost-efficient measure may be chosen for this purpose.

### BRIEF DESCRIPTION OF THE DRAWINGS

In the following, the invention will be explained in detail in embodiments by means of the Figures of the drawing. There show:

FIG. 1 a section through a roof structure of a building which is designed in accordance with the invention;

FIG. 2 a section through a roof structure of a building which is designed conventionally as compared to FIG. 1;

FIG. 3 a section through a wall element with exterior insulation designed in accordance with the invention;

FIG. 4 a section through a wall element in accordance with the invention pursuant to a further embodiment with an interior insulation;

FIG. 5 a perspective view of a heat insulating element in accordance with the invention with accumulated moisture; and

FIG. 6 a diagram for comparing the drying period of heat insulating elements with and without capillary-active fabric.

### DETAILED DESCRIPTION OF EMBODIMENTS OF THE INVENTION

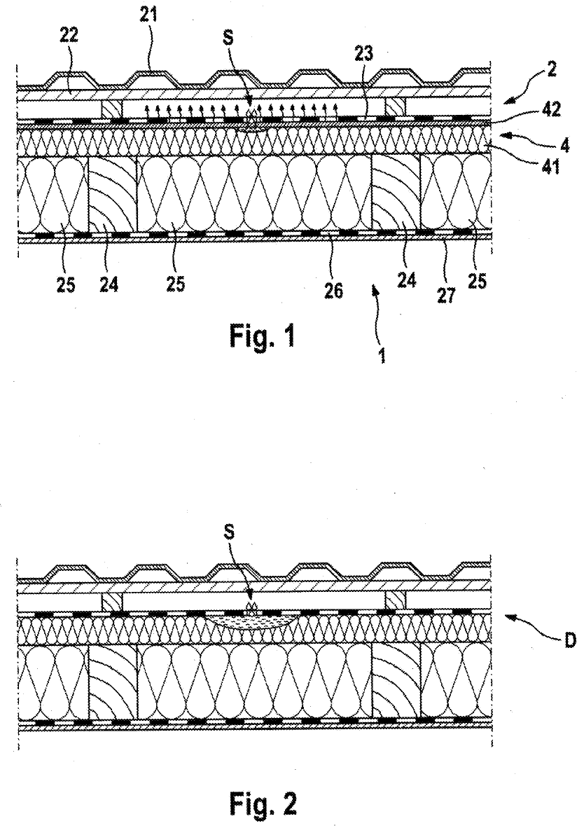

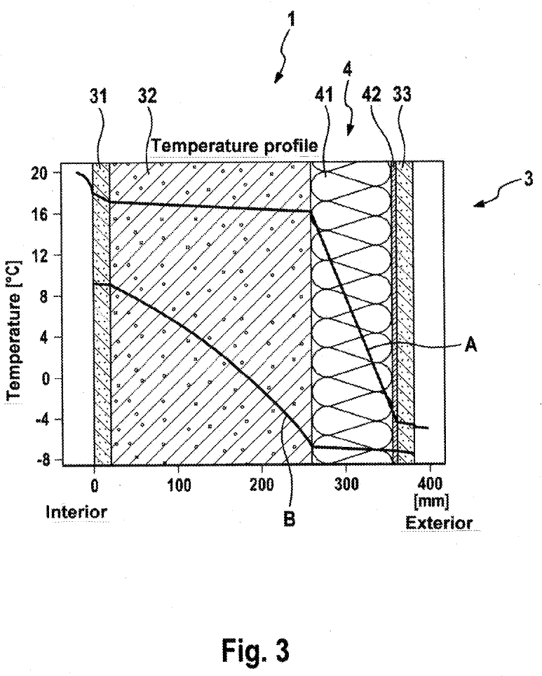

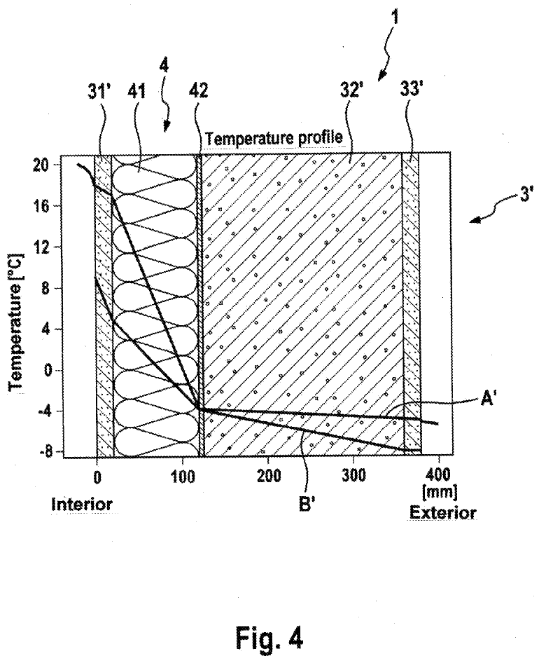

FIG. 1 illustrates a building 1 with a roof structure 2 designed in accordance with the invention. For comparison, a conventional roof structure D is illustrated in FIG. 2. FIGS. 3 and 4 illustrate wall elements 3 and 3′ which are designed in accordance with the invention.

Pursuant to the sectional illustration in FIG. 1 the roof structure 2 comprises a roof covering 21 and a sub construction 22 therefor. Therebelow is positioned a sarking membrane 23 which covers an over rafter insulation formed of heat insulating elements 4. At the outer side the over rafter insulation rests on rafters 24 between which a between rafter insulation 25 is disposed. A vapor barrier 26 and a sheathing 27 form the inner-side termination.

Each heat insulating element 4 comprises an insulating body 41 of mineral wool and a capillary-active fabric, in particular a fleece 42 of glass fibers. The fleece 42 is laminated on the insulating body 41 and is available at the outer side in the direction of the sarking membrane 23.

In the illustrated embodiment the sarking membrane 23 comprises a defect S through which moisture may penetrate onto the over rafter insulation.

For comparison, FIG. 2 illustrates the conventional roof structure D which differs from the structure of the building construction pursuant to FIG. 1 only by the fact that, instead of the heat insulating element 4, a conventional, non-laminated mineral wool plate is disposed as an element of the over rafter insulation. Also in the arrangement pursuant to FIG. 2 a defect S is available in the sarking membrane.

As is shown in the illustration in FIG. 2, moisture enters through the defect S into the mineral wool of the over rafter insulation and damages the structure thereof. The moisture distributes conventionally in correspondence with the usual behavior of water substantially in a drop-shaped manner and is accumulated in the region of the defect S. Therefore, the water can dry only very slowly.

In the roof structure 2 in accordance with the invention pursuant to the illustration in FIG. 1 the insulating body 41 is, on the contrary, laminated with the fleece 42 which is of capillary-active design. The water entered through the defect S distributes along the fleece 42 and covers accordingly a larger area than in the state of the art. No water accumulation as it is known from the state of the art will occur. For this reason, the moisture dries from the heat insulating element 4 substantially more quickly and diffuses on a large face to the outside through the sarking membrane 23.

FIG. 3 illustrates a section through the wall element 3 of the building 1 which is provided with an exterior insulation. It comprises at the inner side a plaster layer 31 which is applied on a supporting wall 32. At the outer side there follows the exterior insulation of heat insulating elements 4. The insulating body 41 rests on the wall 32 while the capillary-active fleece 42 laminated thereon is arranged on the side of the insulating body 41 which faces away from the wall 32. On the fleece 42, finally, an exterior plaster 33 is arranged.

The illustration in FIG. 3 further illustrates by means of a line A the temperature profile in the wall element 3 during the heating period across the wall thickness. With the line B the dew point in the wall element 3 is further illustrated. Since the insulating plane of this exterior wall insulation is available outside of the wall 32, no accumulation of condensation water will occur here as a rule.

It is, however, possible that the exterior plaster 33 is damaged due to external influences or the like and that moisture may thus penetrate into the wall element 3. There, however, this moisture encounters first of all the capillary-active fleece 42 which distributes the moisture directly to a larger face and thus favors the drying thereof. Since the moisture entry typically takes place here and there and only in the case of rain showers, for instance, the time of rain breaks will frequently suffice to achieve a uniform dissipation of moisture across a larger area into the exterior plaster and thus to the environment. Damage of the insulating body 41 can thus be avoided reliably.

FIG. 4 shows the wall element 3′ provided with an interior insulation. Here, too, a plaster layer 31′ is available at the inner side, which is, however, followed by the interior insulation formed of heat insulating elements 4. The insulating body 41 is positioned adjacent to the plaster layer 31′ while the capillary-active fleece 42 is arranged at the side of the insulating body 41 which faces a wall 32′. At the outer side the wall structure is terminated by an exterior plaster 33′.

Also in this illustration is the temperature profile through the wall element 3′ shown by means of a line A′. Likewise, the dew point is plotted by means of a line B′. As is shown in the illustration, the temperature drops strongly within the interior insulation while it experiences only little cooling in the wall 32′. The wall 32′ is available outside of the insulating plane, which results in that condensation water may accumulate at the boundary surface between the wall 32′ and the fleece 42 especially during the heating period. Conventionally, the condensation water would accumulate in this area especially at corners and places of joint, and would lead to mold formation or the like.

By the capillary-active fleece 42 possibly existing moisture is, however, distributed across a large face, so that it can dry easily and quickly. This takes place through the diffusion-open insulating body 41 via the plaster layer 31′ into the interior of the building 1.

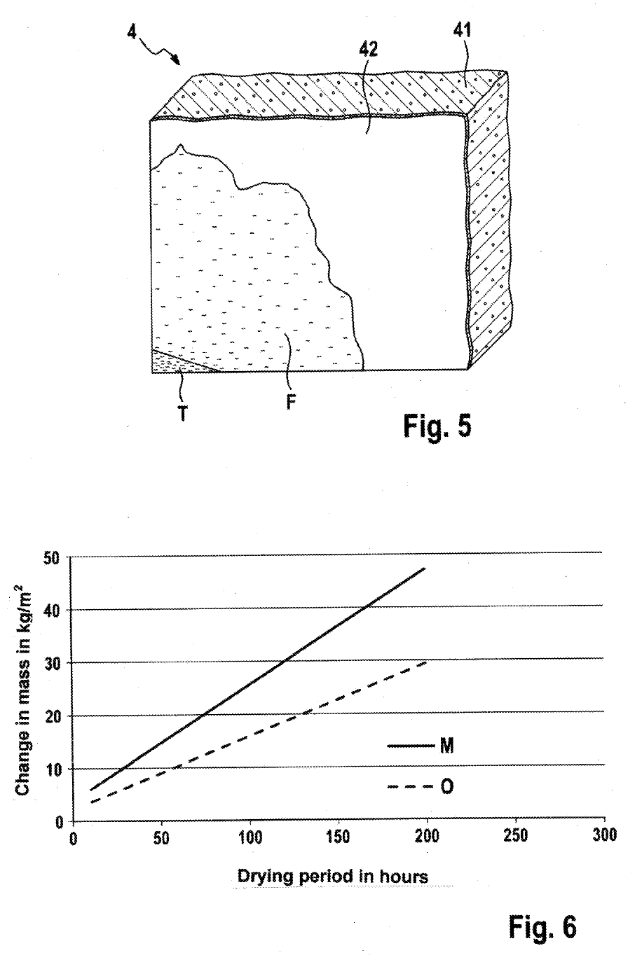

FIG. 5 illustrates a perspective view of a portion of the heat insulating element 4. In the foreground, the capillary-active fleece 42 is illustrated, which is only laminated on a large face on the insulating body 41. As a fleece 42 the product known under the brand name EVO 170 is used.

In the illustrated example the heat insulating element 4 rests against a corner region, for instance, in a window reveal where condensation water T accumulates. The water accumulates directly in the corner, but is then sucked in by the capillary-active fleece 42 and distributed across a larger face F. From there it may dry quickly and may be discharged through the diffusion-open insulating body 41.

Laboratory tests concerning the drying behavior in the corner region of a window reveal as a “worst case” scenario have shown that in this manner a quite substantial acceleration of the drying process may be achieved. FIG. 6 illustrates in a diagram the drying period in hours, wherein a sample with a fleece 42 is plotted with the line M and a sample without the fleece 42 with the line O. The drying period was ascertained by determining the change in mass of the sample since this proceeding appeared suitable to be able to reliably ascertain the remaining moisture content of the sample. The qualitative difference between the sample with the fleece 42 and the sample without the fleece 42 can be recognized directly.

The success of the distribution of moisture on a large face depends predominantly on the capillarity of the fleece 42. The suction distance and the suction velocity of the fleece 42 play an important role here. These parameters depend less on the material of the fleece, but rather on the weaving technique and/or the geometry of the fibers which cooperate here.

Capillarity describes the rising or sucking process of a liquid when getting into contact with narrow tubes (capillaries) or small cavities. The liquid will in this case distribute to a larger face and rise even against gravity. This effect occurs due to the molecular forces in the liquid and the surface tension involved therewith. In the instant application this liquid is as a rule water which is characterized by a large surface tension. Two factors play a quite substantial role here, namely cohesion and adhesion.

Cohesion is the “cohering force” of the molecules in a body. In a liquid the cohesive forces are so small that the molecules may move within the liquid. Adhesion is the “attraction force” between the molecules of two different substances.

If the liquid meets a solid surface and the adhesive forces between this surface and the liquid are stronger than the cohesive forces of the liquid, the liquid will attempt to wet the surface. In this process the molecules of the liquid are attracted by the adhesive forces by the surface of the solid body. Due to the cohesive forces, molecules which were attracted by the surface will drag along the remaining molecules. Thus, a meniscus will form at the contact face, i.e. the liquid will rise at the wall.

The capillary rise of a liquid may be calculated by means of the following equation:

h=2σ cos θ/ρgr

wherein:
h=capillary rise of the liquid
σ=surface tension
θ=contact angle
ρ=density of the liquid
g=gravitational acceleration
r=radius of the capillaries

At 20° C. the surface tension σ for water is 72.75 mN/m. Apart from this the density of water and the acceleration are also constant. If one assumes a contact angle of 0°, a value of 1 will result for the factor cos θ. Thus, the radius of the capillaries r remains as the only variable in this equation.

In the fleece 42 this factor r is determined by the cavities and the weaving structure, from which appropriate capillary rises of water can as a rule be determined by experiments for different fleeces. In the instant embodiments fleeces with a capillarity for water with a capillary rise of more than 15 cm have turned out suitable. If a higher value is chosen, the effect of distribution of the liquid on a larger face is the more distinct.

In addition to the embodiments explained, the invention allows for further design approaches.

Thus, it is not mandatorily necessary that the capillary rise of the fleece 42 is more than 15 cm. For some applications a lower capillary rise of e.g. 10 cm may also be sufficient.

Furthermore, the fleece 42 need not be made of glass fibers. Instead, plastic fibers or mixtures of different kinds of fibers may also be used. Also the kind of weaving of the fleece 42 may be arbitrary per se as long as it is of capillary-active design. Thus, the fleece 42 may, for instance, also be a fleece EVO 130, an Ortmann fleece, or any other suitable capillary-active fleece.

Furthermore, it is not necessary that the fleece 42 is laminated on the insulating body 41. It may also be connected therewith by a needling process or simply be arranged loosely next to it.

The insulating body 41 comprises a water vapor diffusion resistance μ of ≤3. In order to improve the diffusion capacity, a lower μ value may, however, also be chosen, for instance, μ equal to 2.

In the illustrated embodiment the insulating body 41 is formed of mineral wool. Instead, other types of fiber and especially natural fibers such as, for instance, soft wood fibers or the like, may also be used. Mixtures of such fibers are also possible.

1. A heat insulating element (4) for an interior insulation, a facade insulation, a roof insulation, or the like at a building (1), comprising an insulating body (41) which is of diffusion-open design,
characterized in
that the heat insulating element (4) further comprises a fabric (42), especially a fleece, which is of capillary-active design, and
that the fabric (42) is arranged and laminated on a surface of the insulating body (41).

2. The heat insulating element according to claim 1, characterized in that the fabric (42) comprises a capillarity for water with a capillary rise of more than 15 cm, preferably more than 20 cm.

3. The heat insulating element according to claim 1, characterized in that the fabric (42) is formed of glass fibers or plastic fibers.

4. (canceled)

5. The heat insulating element according to claim 1, characterized in that the insulating body (41) has a μ value of ≤3, preferably a μ value of ≤2.

6. The heat insulating element according to claim 1, characterized in that the insulating body (41) is formed of mineral wool or natural fibers, especially soft wood fibers.

7. A building construction with a separator between an inner side and an outer side of a building (1), wherein the inner side corresponds to a warm side of the building (1) and the outer side corresponds to a cold side of the building (1), and with a plurality of heat insulating elements (4) for an interior insulation, a facade insulation, or the like at said building (1) further comprising an insulating body (41) which is of diffusion-open design,
characterized in
that the heat insulating element (4) further comprises a fabric (42) which is of capillary-active design, and
that the fabric (42) is arranged and laminated on a surface of the insulating body (41).

8. The building construction according to claim 7, characterized in that the separator is a wall element (3′) and the heat insulating elements (4) form an interior insulation, wherein the fabric (42) is arranged to face the wall element (3′).

9. The building construction according to claim 7, characterized in that the separator is a wall element (3) and the heat insulating elements (4) form a facade insulation, wherein the fabric (42) is arranged to face away from the wall element (3) toward the outer side.

10. The building construction according to claim 7, characterized in that the separator is a roof structure (2) and the heat insulating elements (4) form a roof insulation, wherein the fabric (42) is arranged to face away from the roof structure toward the outer side.

11. (canceled)

12. A method for avoiding moisture damage at a building (1) comprising a separator such as a wall element (3; 3′) or a roof structure (2) and equipped with heat insulating elements (4) for an interior insulation, a facade insulation, or the like at said building (1) further comprising an insulating body (41) which is of diffusion-open design, wherein the separator is arranged between an inner side and an outer side of a building (1), wherein the inner side corresponds to a warm side of the building (1) and the outer side corresponds to a cold side of the building (1), wherein the method comprises the steps of:
occurring of a moisture accumulation in the region of the fabric (42),
extensively distributing the moisture due to the capillary-active property of the fabric (42) for increasing the area of evaporation,
guiding off the moisture by evaporation and thus drying the area concerned of the fabric (42).

13. The method according to claim 12, characterized in that the moisture is guided off by means of diffusion through the diffusion-open insulating body (41).

14. The method according to claim 12, characterized in that the moisture is guided off by evaporation from the side of the fabric (42) which faces away from the insulating body (41).

15. Use of a heat insulating element according to claim 1 for an interior insulation, a facade insulation, a roof insulation, or the like at a building (1).
